(19) United States
(12) Patent Application Publication
(10) Pub. No.: US 2017/0112721 A1
(43) Pub. Date: Apr. 27, 2017

(54) GASTROSTOMY TUBE COMPRISING A CAP ASSEMBLY

(71) Applicant: Fresenius Kabi Deutschland GMBH, Bad Homburg (DE)

(72) Inventors: Katharina Munnich, Usingen (DE); Klaus Kleve, Warendorf (DE)

(21) Appl. No.: 15/129,290

(22) PCT Filed: Feb. 3, 2015
(86) PCT No.: PCT/EP2015/052116

§ 371 Date: Sep. 26, 2016

(30) Foreign Application Priority Data
Apr. 2, 2014 (EP) 14163160.6

(51) Int. Cl. A61J 15/00

(52) U.S. Cl. CPC A61J 15/0026

(57) ABSTRACT

A gastrostomy tube (1) comprises a head (10) having a port (15) for feeding a fluid, a tube section (11) extending from the head (10) and having a duct (150) for transporting a fluid fed into the port (15), and a cap assembly (2) attachable to the head (10). Herein the cap assembly (2) comprises a cap (20) forming an inner chamber (205), wherein in an assembled state of the gastrostomy tube (1) the head (10) is inserted into the inner chamber (205) of the cap (20). In this way a gastrostomy tube is provided which allows for an aesthetically pleasing appearance of the head of the gastrostomy tube and represent an as small as possible obstacle for a patient in everyday life.

The invention relates to a gastrostomy tube according to the preamble of claim 1 and to a method for assembling a gastrostomy tube.

A gastrostomy tube of this kind comprises a head having a port for feeding a fluid, a tube section extending from the head and having a duct for transporting a fluid fed into the port, and a cap assembly attachable to the head.

A gastrostomy tube of this kind, also known as “low-profile gastrostomy tube”, “gastric feeding tube” or “gastrostomy button”, in short “G-tube” or “G-button”) provides an access for the long-term enteral feeding of a patient. The tube section of the gastrostomy tube is inserted through a small incision in the abdomen of the patient into the stomach such that the head of the gastrostomy tube is placed outside of the patient and the tube section extends into the stomach of the patient. The tube section may, for example, be held within the stomach by means of an inflatable balloon arranged on the far end of the tube section or by means of a retention dome which is wider than the tract of the tube. An external tubing can be attached to the port of the head to feed a nutritional fluid into the stomach of the patient via the gastrostomy tube.

Gastrostomy tubes of this kind are used by patients over a long period of time. Such gastrostomy tubes in particular are used on mobile patients which are not stationary in a hospital, but who lead a regular live outside of a hospital. Hence, such gastrostomy tubes are designed to impact the everyday life of a patient as little as possible.

Since the head of the gastrostomy tube is placed outside of the patient when the gastrostomy tube, with its tube section, is inserted into the patient, it is visible from the outside. This may on the one hand represent a psychological factor in that a patient constantly is reminded of the gastrostomy tube and its medical nature. On the other hand the gastrostomy tube may also be visible to other people, for example in a swimming pool. In particular for children this may severely impact the comfort and well-being of the patient carrying the gastrostomy tube.

There, hence, is a desire to hide the gastrostomy tube towards the outside as well as possible. The gastrostomy tube shall not hinder the mobility of the patient and just as well shall not pose a severe psychological burden on the patient.

In U.S. Pat. No. 8,287,502, it has been suggested to place a cap assembly on the head of a gastrostomy tube, the cap assembling comprising a mounting platform attachable to the head and a disc-shaped cap connectable to the mounting platform. The cap may have a colorful design or may carry a logo of for example a sports team. The cap hence represents a decorative attachment that covers the head of the gastrostomy tube towards the outside in an appealing way.

Because a mounting platform is needed to fix the cap on the head, the arrangement overall is rather large and hence may represent an obstacle for the patient, for example when clothes are caught by the cap. Further, because the disc-shaped cap covers the head only towards one side, the head may still be visible from the outside.

From WO 2012/106178 A2 an enteral feeding tube is known which provides a conduit for the flow of liquid nutritional material. The enteral feeding tube comprises a housing, the housing having an aesthetically pleasing shape such as the shape of an animal, for example of a turtle.

It is an object of the instant invention to provide a gastrostomy tube and a method for assembling a gastrostomy tube which allow for an aesthetically pleasing appearance of the head of the gastrostomy tube and represent an as small as possible obstacle for a patient in everyday life.

This object is achieved by means of a gastrostomy tube having the features of claim 1.

Accordingly, the cap assembly comprises a cap forming an inner chamber, wherein in an assembled state of the gastrostomy tube the head is inserted into the inner chamber of the cap.

The instant invention starts from the idea to use a cap to cover the head of the gastrostomy tube towards the outside such that the head is not visible from the outside. This serves on the one head to provide an aesthetically pleasing appearance of the head towards the outside such that the patient is not constantly reminded of the gastrostomy tube and its medical nature. On the other hand, the gastrostomy tube cannot be recognized as such by other people, who will possibly see only the cap, but not the head of the gastrostomy tube and hence cannot recognize the head and its medical function.

The cap on the one hand provides a cover for the head towards the outside and hence may have an aesthetically pleasing shape, color and design. For example, the cap may have the shape of an animal, a toy, a piece of jewelry or the like and may in addition carry a decorative, in particular colorful motive such as a logo or decorative ornament such that the cap represents a decorative element. Further, the cap may have a shape such that it does not represent an obstacle. For example, the cap may be rounded such that clothes cannot be caught by the cap.

In order to make sure that the head is not visible from the outside, the head is inserted into the inner chamber formed by the cap of the cap assembly. Hence, the head is received in the inner chamber of the cap such that it is—at least partially—enclosed by the cap assembly. The cap hence covers the head of the gastrostomy tube not only towards one side, but receives the head in its inner chamber. This allows for masking the head towards the outside such that the head is not visible to other people from the outside.

In one embodiment, the cap beneficially has a bottom opening which opens the inner chamber towards the side of the head at which the tube section extends from the head. Through the bottom opening the head can be inserted into the cap such that the head is received in the inner chamber formed by the cap.

The bottom opening of the cap, in one embodiment, is surrounded by a bottom edge, wherein the head placed inside the inner chamber does not extend towards the outside beyond the bottom edge. The head of the gastrostomy tube hence is fully received in the inner chamber of the cap and does not protrude from the cap towards the outside. With its bottom edge the cap may be placed on the skin of the patient such that the cap sits closely on the patient's skin and encloses the head in its inner chamber. The head hence is not visible from the outside.

In this regard it shall be noted that the inner chamber may be constituted to only partially receive the head of the gastrostomy tube. The head not necessarily is fully received in and enclosed by the cap of the cap assembly.

The cap may for example be made of a plastic material. The cap may have a rounded design and may be made of a soft and/or hard plastic. The cap may for example be fabricated by injection molding.

The cap may be fitted for example to the head in a force-locking manner or in a positive locking manner. The cap in one embodiment is releasably attachable to the head such that different caps may be used and attached to the head of a gastrostomy tube. For example, a patient may change the cap on a daily basis and, depending on his or her mood and wishes, may use caps of different shapes and designs.

In the assembled state, the cap may be held on the head for example in a clamping fashion such that a force locking or positive locking engagement between the cap and the head is achieved. For example, the cap may be placed on the head such that the cap is press-fitted to the head. Or the cap may comprise one or multiple locking elements which provide a mechanical lock between the cap and the head such that a positive locking engagement between the cap and the head is achieved.

A locking element of this kind may for example protrude from an inner wall of the cap. In the assembled state of the gastrostomy tube, in which the cap is assembled on the head, the locking element is in mechanical engagement with the head and hence fixes the cap on the head.

For placing the cap on the head, in one embodiment the cap may be deformable such that it can be deformed from a relaxed, first state into a deformed, second state for inserting the head into the inner chamber of the cap. By means of such deformation, one or multiple locking elements of the cap or the head can be brought into engagement with corresponding locking elements on the head respectively the cab, wherein upon insertion of the head into the inner chamber of the cap the cap returns to its relaxed, first state and in this way establishes a connection between the cap and the head in a force locking or positive locking manner.

In a particular embodiment, the cap is formed in one piece from two plastic components having different elastic characteristics, in particular different modules of elasticity. A cap of this kind may for example be fabricated by using two-component molding techniques or even multi-component molding techniques to obtain an integral cap of different materials.

The cap hence may comprise a first, rigid section and a second, soft section, wherein in particular the second, soft section may be deformed in an elastic fashion for placing the cap on the head. By using a two-component molding technique (or even a multi-component molding technique employing more than two materials) a cap may be fabricated in a rather cheap way and comprising a desired deformability as well as a sufficient rigidity.

In another embodiment, the cap assembly may comprise a bottom part attachable to the cap for fixing the cap to the head. The bottom part may for example be hingedly connected to the cap such that the two parts of the cap assembly, namely the cap and the bottom part, are connected to each other by for example an integral hinge. In the assembled state the bottom part and the cap are locked to each other for example in a positive locking manner, wherein the head is held in the inner chamber in between the bottom part and the cap.

In the assembled state, the bottom part for example may at least partially close a bottom opening of the cap through which the head can be inserted into the inner chamber formed by the cap. By lockingly connecting the bottom part to the cap the bottom opening of the cap hence at least partially is closed such that the head is caught in the inner chamber of the cap and cannot be removed from the inner chamber of the cap without detaching the bottom part from the cap.

The bottom part, in the assembled state, abuts a bottom face of the head facing the skin of the patient. From the bottom face of the head the tube section extends towards the patient, passing through an opening in the bottom part.

For fixing the bottom part to the cap in a positive locking manner the bottom part may for example carry one or multiple flanges protruding from the bottom part towards the inside of the inner chamber. Such flanges may abut the head in the assembled state of the gastrostomy tube and may receive the head in-between them. The flanges may for example comprise suitable locking elements for engaging with locking elements of the cap such that a positive locking engagement between the locking elements of the bottom part and the locking elements of the cap can be established.

Just as well the bottom part may comprise a curved rim extending circumferentially around a base plate of the bottom part and carrying one or multiple locking elements. In this case the inner chamber for receiving the head may be formed by the cap and the bottom part in conjunction, wherein the head of the gastrostomy tube in the assembled state of the gastrostomy tube is held within the inner chamber in between the cap and the bottom part.

The head, in one embodiment, may be connected to an elastic strap which is constituted to close the port arranged on the head. The elastic strap may for example carry a pin which may be inserted into the port of the head such that, in a closed state, the port is closed towards the outside.

It shall be noted that the port of the head commonly comprises a valve which allows for feeding a fluid, for example a nutritional liquid, through the tube section into the stomach of a patient, but which blocks a reverse flow from the stomach towards the outside. The strap, in this regard, has the primary function of preventing dirt to enter the port.

The strap connected to the head, in one embodiment, in the assembled state is arranged within the inner chamber formed by the cap. The strap, together with the head, hence, is fully enclosed in the inner chamber in a state in which it is attached to the port for closing the port.

In another, alternative embodiment, the cap is designed such that it in the assembled state does not receive the strap in its inner chamber, but only the head. The strap, in this embodiment, extends from the head placed inside the inner chamber around the cap on the outside of the cap such that the strap extends along the outer surface of the cap. To enable the strap to close the port of the head the cap in this embodiment comprises a port opening associated with the port of the head such that the strap can be attached to the port for closing the port towards the outside. By detaching the strap from the port, the port can be accessed from the outside such that an external tubing can be attached to the port for feeding a fluid, for example a nutritional liquid, to the patient. For this, the cap does not have to be removed from the head, but can be left in place on the head.

The object is also achieved by a method for assembling a gastrostomy tube, the gastrostomy tube comprising
a head having a port for feeding a fluid,
a tube section extending from the head and having a duct for transporting a fluid fed into the port, and
a cap assembly attachable to the head.

Herein, the cap assembly comprises a cap forming an inner chamber, wherein for assembling the gastrostomy tube the head is inserted into the inner chamber of the cap such that it is received in the inner chamber.

The advantages and advantageous embodiments described above for the gastrostomy tube equally apply also to a method for assembling the gastrostomy tube such that it shall be referred to the above.

The idea underlying the invention shall subsequently be described in more detail with reference to the embodiments shown in the figures. Herein,

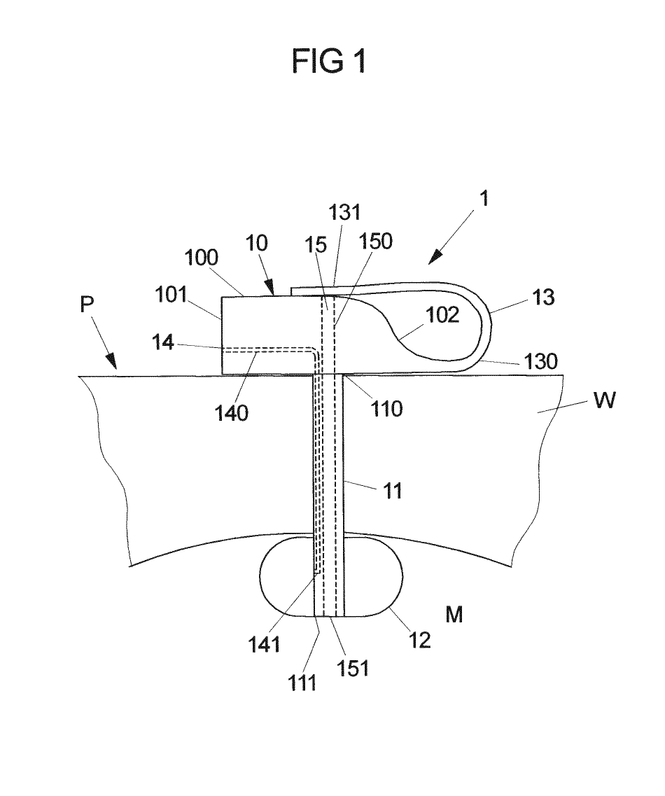

FIG. 1 shows a schematic drawing of a gastrostomy tube inserted into a patient;

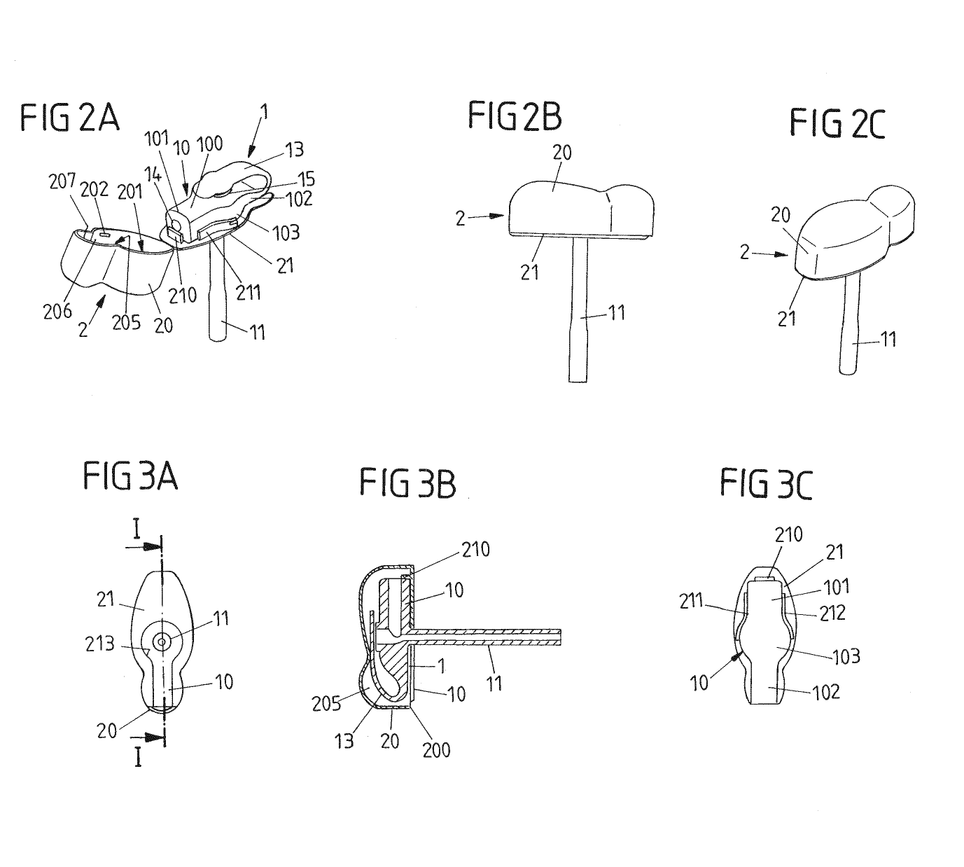

FIG. 2A-2C show different views of a first embodiment of a cap assembly attached to the head of the gastrostomy tube;

FIG. 3A shows a bottom view of the head with the cap assembly attached thereto;

FIG. 3B shows a cross-sectional view along line I-I according to FIG. 3A;

FIG. 3C shows a top view of a bottom part of the cap assembly attached to the head, with a cap of the cap assembly removed;

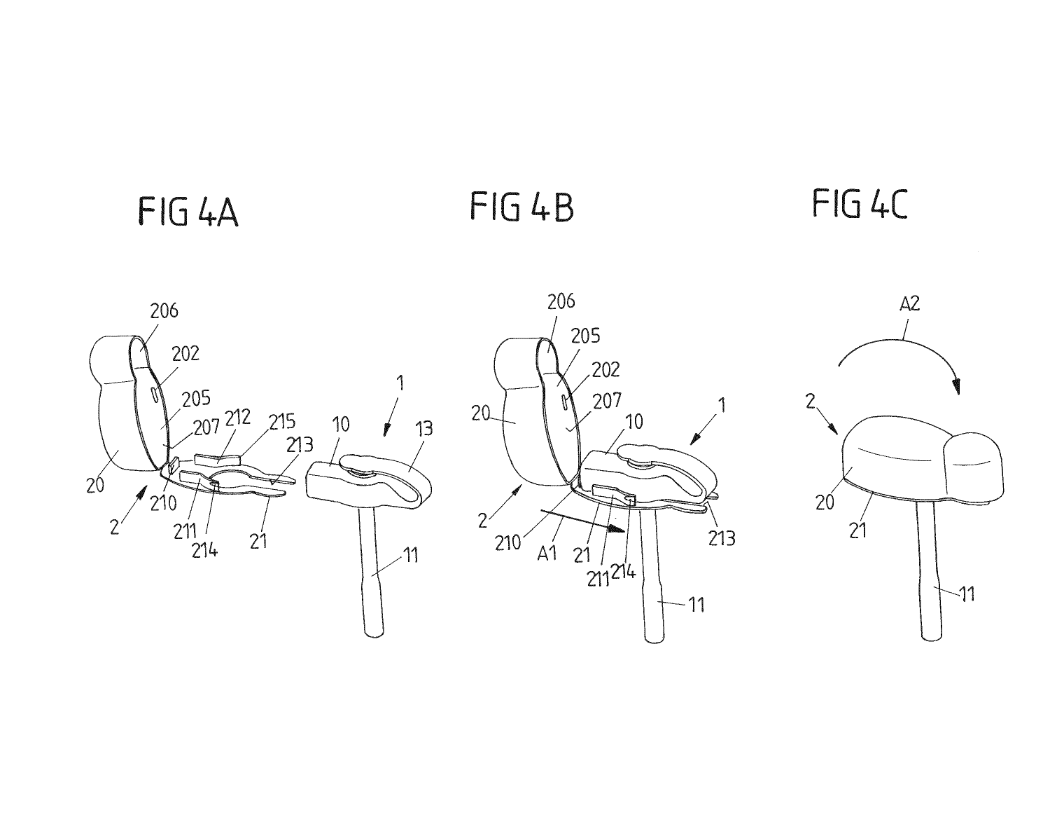

FIG. 4A-4C show views of the gastrostomy tube and the cap assembly during the attachment of the cap assembly to the head of the gastrostomy tube;

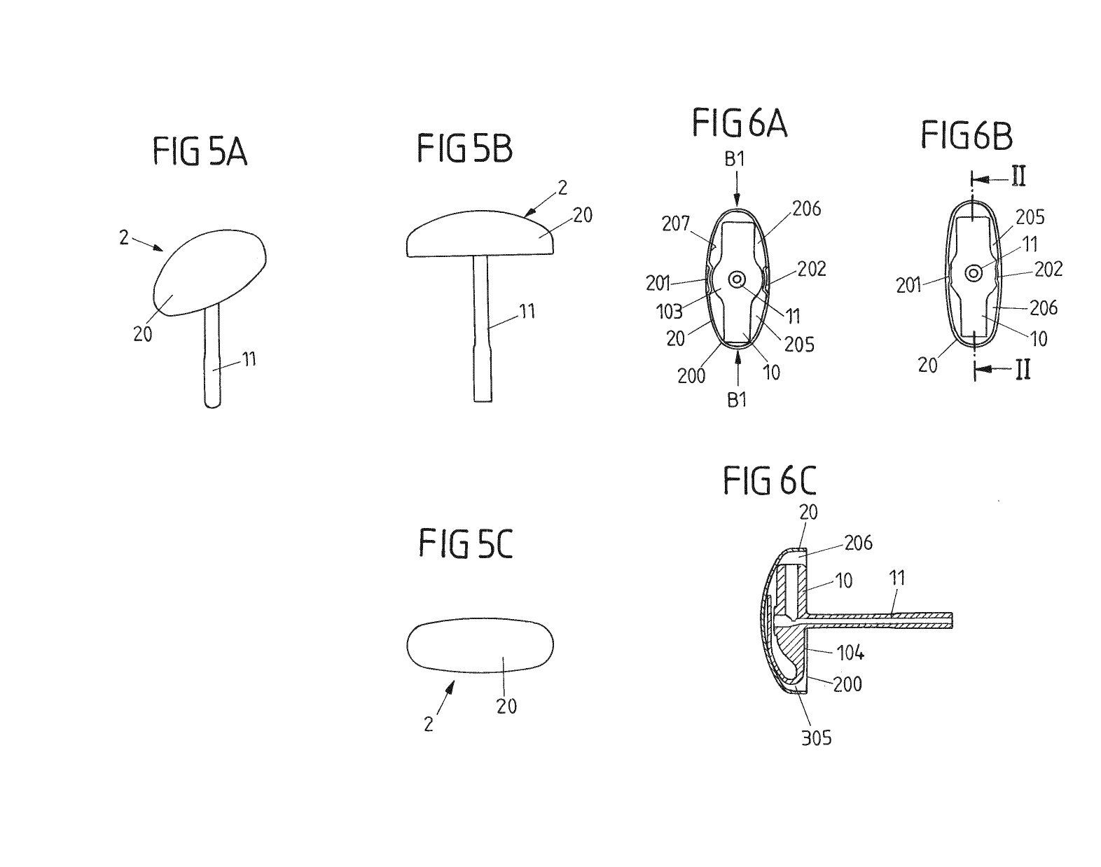

FIG. 5A-5C show different views of a second embodiment of a cap assembly attached to the head of the gastrostomy tube;

FIG. 6A shows a bottom view of the head, while attaching a cap of the cap assembly to the head;

FIG. 6B shows a bottom view of the head with the cap of the cap assembly attached thereto;

FIG. 6C shows a cross-sectional view along line II-II according to FIG. 6B;

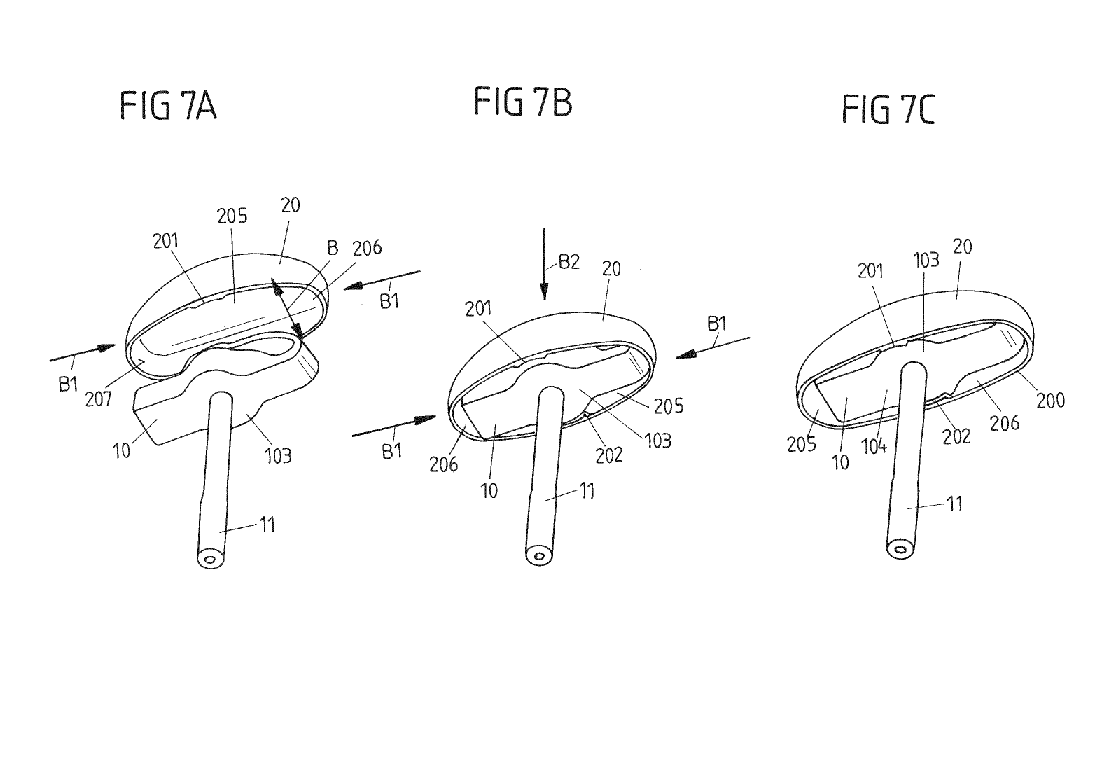

FIG. 7A-7C show different views while attaching the cap assembly to the head of the gastrostomy tube;

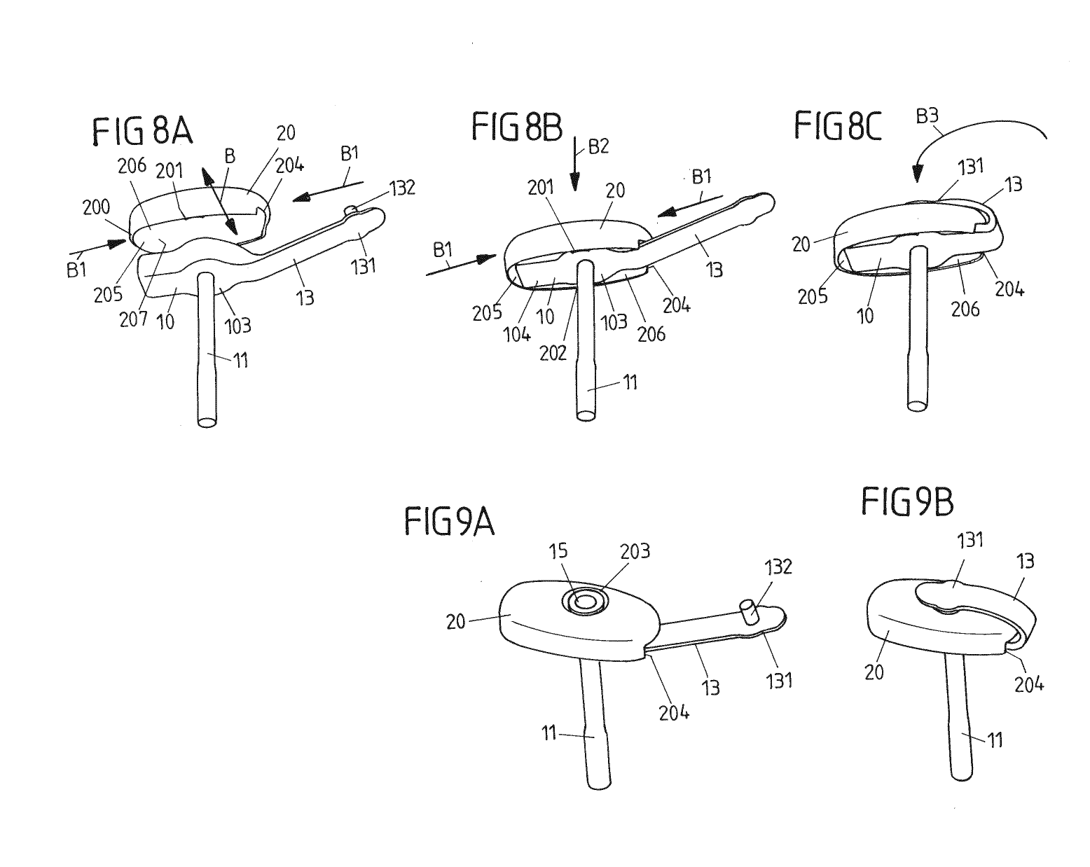

FIG. 8A-8C show different views of another embodiment of a cap assembly, while attaching the cap assembly to the head of the gastrostomy tube;

FIG. 9A shows a view of the cap assembly attached to the head, with a strap removed from a port of the head;

FIG. 9B shows the view of FIG. 9A, with the strap attached to the port of the head;

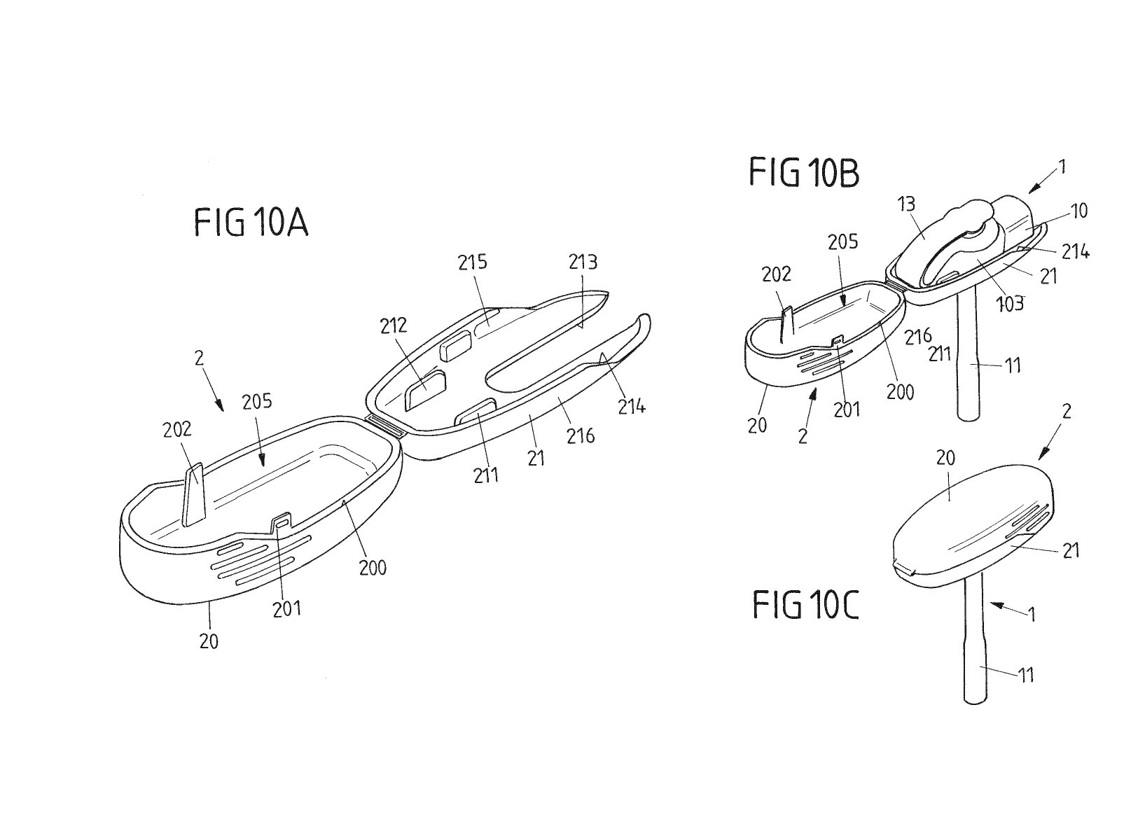

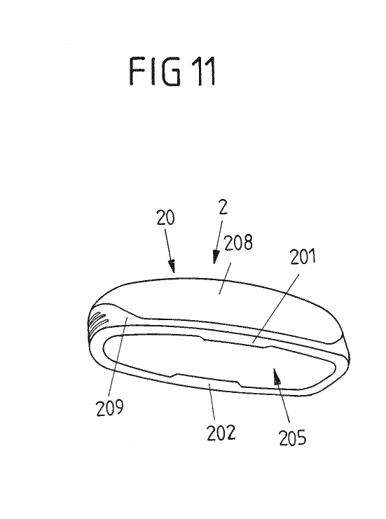

FIG. 10A-10C show different views of another embodiment of a cap assembly; and

FIG. 11 shows a view of yet another embodiment of a cap assembly.

FIG. 1 shows a schematic view of a gastrostomy tube 1 inserted into a patient P. The gastrostomy tube 1, as known per se, comprises a head 10, which is placed outside the patient P, and a tube section 11 extending from the head 10 through a stomach wall W towards a stomachs M of the patient P.

The tube section 11 adjoins with a first end 110 the head 10 and with a second, far end 111 is placed within the stomach M of the patient P. At the second end 111 the tube section 11 carries a fixing device, for example an inflatable balloon 12, which prevents the gastrostomy tube 1 from slipping out of the incision in the stomach wall W through which the tub section 11 extends.

The head 10 comprises a first port 15 to which an external tubing may be attached to feed a fluid, in particular a nutritional liquid, through a duct 150 and an opening 151 into the stomach M of the patient P. The port 15 comprises a valve which allows for a feeding of a fluid into the stomach M, but prevents liquids to pass from the stomach M towards the outside.

The head 10 comprises a head body 100 having a first end 101 and a second end 102. At the second end 102 a strap 13 is integrally connected to the head body 100 with a strap end 130. The strap 13 extends elastically from the head body 100 and is bent with a far end 131 towards the port 15 such that, by means of a pin 132 (see FIG. 9A), the port 15 may be closed towards the outside so that dirt or other undesired matter may not enter the port 15 from the outside when no external tubing is connected to the port 15.

At the first end 101 of the head body 100 another, second port 14 is arranged which is in connection with a duct 140 providing a fluid connection to the balloon 12. The duct 140, with an opening 141, is in a fluid connection with the balloon 12 such that a fluid, for example water, may be fed into the balloon 12 for inflating the balloon 12 within the stomach M of the patient P.

The head 10 is placed outside the patient P when the gastrostomy tube 1 is inserted into the patient P. The head 10 with its ports 14, 15 and the strap 13 herein has a rather technical, medical appearance, which shall be—according to the instant invention—covered by a cap assembly 2 shown in different embodiments in FIG. 2A-2C to FIG. 11.

A first embodiment of such a cap assembly 2 is shown in FIG. 2A-2C to 4A-4C. The cap assembly 2 comprises a cap 20 forming an inner chamber 205 into which the head of the gastrostomy bottom 1 can be inserted such that, when the cap assembly 2 is attached to the head 10, the head 10 is fully enclosed in the cap 20, as shown in FIGS. 2B and 2C.

The cap 20 is hingedly connected to a bottom part 21 which comprises an opening 213 into which the tub section 11 of the gastrostomy bottom 1 can be inserted. The bottom part 21 may be slid beneath the head 10 such that the bottom part 21 faces a bottom face 104 of the head 10 from which the tub section 11 extends. In an attached state, as shown for example in FIG. 4B, the head 10 with its end 101 abuts a stop 210 protruding from the bottom part 21 and further is received in between flanges 211, 212 arranged on the bottom part 21. The flanges 211, 212 herein conform to the shape of the head 10 and in particular are formed to receive a rounded section 103 of the head 10 in between them, the rounded section 103 having a generally cylindrical shape and carrying the port 15.

The cap 20 forms the inner chamber 205 in which the head 10 is received when the cap assembly 2 is attached to the head 10. The cap 20 has an opening 206 which opens the inner chamber 205 towards the bottom of the cap assembly 2 such that the head 10 can be inserted into the inner chamber 205 through the opening 206. The opening 206 is surrounded by a bottom edge 200, the bottom edge 200 abutting the bottom part 21 in an assembled state of the cap assembly 2 in which the cap assembly 2 is arranged on the head 10.

On an inner wall 207 of the cap 20 two locking elements 201, 202 in the shape of locking protrusions protruding towards the inside of the inner chamber 205 are arranged. The two locking elements 201, 202 serve to lock the cap 20 with the bottom part 21 in the assembled state in that the locking elements 201, 202 are lockingly received in locking grooves 214, 215 on the flanges 211, 212 of the bottom part 21 (see FIGS. 4A and 4B).

For attaching the cap assembly 2 to the head 10, the bottom part 21 first is slid onto the tube section 11 in a direction A1 (see FIG. 4B) such that the bottom part 21 is arranged beneath the head 10 facing the bottom face 104 of the head 10. Herein, the head 10 is received in between the flanges 211, 212 and abuts the stop 210 once the bottom part 21 is fully slid onto the head 10.

Upon attaching the bottom part 21 to the head 10, the cap 20 is pivoted with respect to the bottom part 21 such that the cap 20 receives the head 10 within its inner chamber 205, as shown in FIG. 4C. By placing the cap 20 on the bottom part 21 the locking elements 201, 202 of the cap 20 are caused to engage the locking grooves 214, 215 on the flanges 211, 212 such that the cap 20 is locked to the bottom part 21 in a positive locking manner.

In the assembled state, as shown in FIG. 4C, the head 10 is received in the inner chamber 205 of the cap 20, wherein the inner chamber 205 is at least partially closed by the bottom part 21 such that the head 10 is securely held within the cap 20.

The inner chamber 205 herein is dimensioned such that it fully receives the head 10. In particular, as visible for example from the cross-sectional view of FIG. 3B, the head 10 with its bottom face 104 does not extend beyond the bottom edge 200 of the cap 20 towards the outside when it is inserted into the inner chamber 205.

In the assembled state, as shown in FIG. 4C, the head 10 is not visible from the outside, but is fully covered by the cup 20. The head 20 herein may be designed and shaped in an esthetically pleasing fashion. For example, the cap 20 may have the shape of an animal, a toy or a piece of jewelry such that the gastrostomy tube 1, when viewed from the outside, does not appear as a medical device, but rather as a decorative element.

The cap 20 and the bottom part 21 may in this embodiment be formed integrally in one piece and may be connected to each other by an integral hinge.

The cap 20 and the bottom part 21, in this embodiment, may for example be formed by a rather rigid plastic material.

Another embodiment of a cap assembly is shown in FIG. 5A-5C to 7A-7C. In this embodiment, the cap assembly 2 comprises a cap 20, but no bottom part. The cap 20 has a generally rounded shape and forms an inner chamber 205 for receiving the head 10 of the gastrostomy tube 1 inside.

In the embodiment of FIG. 5A-5C to 7A-7C two locking elements 201, 202 are arranged on the inner wall 207 of the cap 20, protruding towards the inside of the inner chamber 205. The locking elements 201, 202 are arranged immediately on a bottom edge 200 of the cap 20, the bottom edge 200 surrounding an opening 206 which opens the inner chamber 205 towards the outside such that the head 10 may be inserted into the inner chamber 205 through the opening 206.

For placing the cap 20 on the head 10, first the cap 20 is deformed by asserting a pressure in a direction B1 onto the cap 20, as it is shown in FIG. 7A. By asserting a pressure onto the cap 20 along the longitudinal axis of extension of the cap 20, the width

B of the cap 20 is increased transverse to the direction B1 such that the cap 20 may be placed on the head 10 in a direction B2, as it is shown in FIG. 7B.

Once the cap 20 is placed on the head 10 and the head 10 is fully inserted into the inner chamber 205, the pressure is released from the cap 20 such that the cap 20 deforms back to its original, relaxed state. This causes the width B of the cap 20 to return to its original, reduced width, causing the locking element 201, 202 at the bottom edge 200 of the cap 20 to lockingly engage with the bottom face 104 of the head 10 such that the head 10 is mechanically locked within the inner chamber 205 of the cap 20, as it is shown in FIG. 7C.

Within the embodiments of FIG. 2A-2C to 4A-4C and FIG. 5A-5C to 7A-7C the strap 13 connected to the head 10 is received within the inner chamber 205 of the cap 20, as it can be seen from the cross-sectional views of FIG. 3B and FIG. 6C, respectively, for the different embodiments.

However, it also is conceivable in both embodiments that the strap 13, in the assembled state of the cap assembly 2, is not received within the inner chamber 205, but reaches around the cap 20 for closing the port 15 from the outside of the cap 20.

This is illustrated in the embodiment of FIGS. 8A-8C and 9A-9B. In this embodiment (which represents a modification of the embodiment of FIG. 5A-5C to 7A-7C) the cap 20, at its bottom edge 200, comprises a recess 204 through which the strap 13 may reach, as shown in FIGS. 8B and 9A. The cap 20, at its top, comprises a port opening 203 which is associated with the port 15 such that the port 15 may be accessed from the outside through the port opening 203.

For assembling the cap 20 on the head 10, first the strap 13 with its end 131 carrying the pin 132 is removed from the port 15, as shown in FIG. 8A. Upon attaching the cap 20 to the head (FIGS. 8B and 9A) the strap 13 is bent in a direction B3 around the cap 20 (FIGS. 8C and 9B) and the pin 132 is inserted into the port 15 for closing the port 15 towards the outside.

In the assembled state, shown in FIGS. 8C and 9B, the strap 13 is placed outside of the cap 20.

In this embodiment, the port 15 can be accessed from the outside for example for connecting an external tubing to the port 15 for feeding a nutritional liquid to the patient P without removing the cap 20 from the head 10 of the gastrostomy tube 1. For connecting an external tubing to the port 15 the strap 13 is released from the port 15 such that the port 15 is accessible and can be connected to the external tubing.

In another embodiment, shown in FIG. 10A to 10C, the cap assembly 2 comprises a cap 20 hingedly connected to a bottom part 21. Herein, in modification to the embodiment of FIG. 2A-2C to 4A-4C, the bottom part 21 comprises a curved rim 216 protruding towards the cap 20 and conforming to the shape of the cap 20.

In the assembled state the cap 20 together with the bottom part 21 forms an inner chamber 205 in which the head 10 is received such that it is fully covered and not visible from the outside.

Two locking elements 201, 202 are arranged on the bottom edge 200 of the cap 20 protruding towards the bottom part 21. In the assembled state the locking elements 201, 202 engage with corresponding locking grooves 214, 215 on the inside of the curved rim 216 of the bottom part 21 such that the cap 20 is mechanically locked to the bottom part 21, as shown in FIG. 10C.

In this embodiment, flanges 211, 212 protrude from the bottom part 21 and receive the head 10 in between them, as shown in FIG. 10B. The flanges 211, 212 serve to provide a defined seat of the head 10 on the bottom part 21, as shown in FIG. 10B, but—in contrast to the embodiment of FIG. 2A-2C to 4A-4C—do not carry locking grooves.

Other than that the embodiment of FIG. 10A to 10C is functionally identical to the embodiment of FIG. 2A-2C to 4A-4C, such that it shall also be referred to the above.

In the embodiment of FIG. 5A-5C to 7A-7C the cap 20 is deformable such that it can be deformed from its original, relaxed state into a deformed state in which it can be placed on the head 10 of the gastrostomy tube 1. For this, the cap 20 is made and shaped in such a way that it is sufficiently elastic and may be fabricated for example from a sufficiently soft, elastic plastic material.

In a modification according to the embodiment of FIG. 11 the cap 20 is formed by different plastic materials of which a first material has rather rigid characteristics and a second material is sufficiently elastic such that the cap 20 may be deformed in particular in such portions in which it is fabricated from the second, elastic material.

In the specific embodiment depicted in FIG. 11 the cap 20 comprises a first portion 208 in which it is made of a rather rigid material and a second portion 209 in which it is made of a soft, elastic material. The cap 20, accordingly, is deformable in particular in its second portion 209.

The cap 20 as shown in FIG. 11 may for example be fabricated by two-component molding and hence may be fabricated in a rather inexpensive manner.

The idea underlying the invention is not limited to the embodiments described above, but may be implemented in an entirely different fashion in entirely different embodiments.

In particular, caps may have a different shape, design and outward appearance than described herein. The caps may for example have a colorful design for providing a particularly pleasing outward appearance.

The caps of the cap assemblies described herein may be easily removable from an associated head of a gastrostomy tube such that one cap may be replaced by another for changing the outward appearance. A gastrostomy tube herein may be delivered with a set of different caps such that a patient, according to his or her wishes, may use a cap of his or her choice and may exchange one cap with another.

### LIST OF REFERENCE NUMERALS

1 Gastrostomy tube
10 Head
100 Head body
101,102 End
103 Rounded section
104 Bottom face
11 Tube section
110, 111 End
12 Balloon
13 Strap
130, 131 End
132 Pin
14, 15 Port
140, 150 Duct
141, 151 Opening
2 Cap assembly
20 Cap
200 Bottom edge
201, 202 Locking element
203 Port opening
204 Recess
205 Chamber
206 Opening
207 Inner wall
208, 209 Portion
21 Plate
210 Stop
211, 212 Flange
213 Opening
214, 215 Locking groove
216 Curved rim
A1, A2 Direction
B1, B2 Direction
B Width
M Stomach
P Patient
W Stomach wall

1. A gastrostomy tube, comprising:
a head having a port for feeding a fluid,
a tube section extending from the head and having a duct for transporting a fluid fed into the port, and
a cap assembly attachable to the head,
characterized in
that the cap assembly comprises a cap forming an inner chamber, wherein in an assembled state of the gastrostomy tube the head is inserted into the inner chamber of the cap.

2. The gastrostomy tube according to claim 1, characterized in that the cap has a bottom opening opening the inner chamber towards a side of the head at which the tube section extends from the head.

3. The gastrostomy tube according to claim 2, characterized in that the bottom opening of the cap is surrounded by a bottom edge, wherein the head placed inside the inner chamber does not extend towards the outside beyond the bottom edge.

4. The gastrostomy tube according to claim 1, characterized in that the cap is fitted to the head in a force locking manner or in a positive locking manner.

5. The gastrostomy tube according to claim 1, characterized in that the cap comprises at least one locking element providing a positive locking engagement for fitting the cap to the head.

6. The gastrostomy tube according to claim 5, characterized in that the at least one locking element protrudes from an inner wall of the cap and is in mechanical engagement with the head for fixing the cap to the head in the assembled state.

7. The gastrostomy tube according to claim 1, characterized in that the cap at least in sections is formed from an elastic material such that the cap is deformable from a relaxed state into a deformed state for inserting the head into the inner chamber, wherein upon insertion of the head into the inner chamber the cap is resettable into the relaxed state for establishing a connection between the cap and the head.

8. The gastrostomy tube according to claim 1, characterized in that the cap is formed in one piece from two plastic components having different elastic characteristics.

9. The gastrostomy tube according to claim 1, characterized in that the cap assembly comprises a bottom part attachable to the cap for fixing the cap to the head.

10. The gastrostomy tube according to claim 9, characterized in that the cap is hingedly connected to the bottom part.

11. The gastrostomy tube according to claim 9, characterized in that in the assembled state the bottom part and the cap are locked to each other in a positive locking manner, wherein the head is held in the inner chamber by the bottom part locked to the cap.

12. The gastrostomy tube according to claim 9, characterized in that the bottom part, in the assembled state, is placed on a bottom face of the head from which the tube section extends, wherein the bottom part comprises an opening for receiving the tube section.

13. The gastrostomy tube according to claim 9, characterized in that the bottom part carries at least one flange protruding from a side of the bottom part facing the head and abutting the head in the assembled state, wherein the at least one flange is constituted to engage with at least one locking element of the cap for locking the cap to the bottom part.

14. The gastrostomy tube according to claim 1, characterized in that the head is connected to an elastic strap for closing the port, wherein the strap in the assembled state
is arranged in the inner chamber or
extends from the head and reaches around the cap on the outside of the cap, wherein the cap comprises a port opening enabling an access to the port of the head arranged in the inner chamber.

15. A method for assembling a gastrostomy tube , the gastrostomy tube comprising:
a head having a port for feeding a fluid,
a tube section extending from the head and having a duct for transporting a fluid fed into the port, and
a cap assembly attachable to the head,
characterized in
that the cap assembly comprises a cap forming an inner chamber, wherein for assembling the gastrostomy tube the head is inserted into the inner chamber of the cap such that it is received in the inner chamber.
